(19) United States
(12) Patent Application Publication
(10) Pub. No.: US 2022/0071279 A1
(43) Pub. Date: Mar. 10, 2022

(54) VIBRATING HOOKAH AND METHOD OF USING SAME

(71) Applicant: DABBLE VENTURES, LLC, SUNLAND, CA (US)

(72) Inventor: VAHAN GHAZARIAN, SUNLAND, CA (US)

(73) Assignee: DABBLE VENTURES, LLC, SUNLAND, CA (US)

(21) Appl. No.: 17/526,414

(22) Filed: Nov. 15, 2021

Related U.S. Application Data
(63) Continuation-in-part of application No. 16/794,417, filed on Feb. 19, 2020.
Application No. 16/794,417 is a continuation-in-part of application No. 16/241,385, filed on Jan. 7, 2019.
Application No. 16/241,385 is a continuation-in-part of application No. 15/587,340, filed on May 4, 2017, now Pat. No. 10,173,185.
(60) Provisional application No. 62/344,202, filed on Jun. 1, 2016.

(51) Int. Cl. A24F 1/30; A24F 5/00

(52) U.S. Cl. CPC A24F 1/30; H02N 2/001; A24F 5/00

(57) ABSTRACT

A hookah includes a column along an axis provided with a channel for passage of vapor. A container below the column is in fluid-flow communication with the channel for receiving water. A bowl above the column is in fluid-flow communication with the channel and includes a perforated member arranged transversely to the axis to form a lower region for receiving a substance to be smoked and an upper region for supporting briquettes. A down stem extends the channel into the container. A hose port is in fluid-flow communication with the interior of the container. A hose is connected to the hose port and provided with a mouthpiece. A vibrating device selectively vibrates the bowl to break up and release ash formed on the briquettes to expose the briquettes to oxygen to thereby enhance combustion and the generation of heat that can be applied to the substance to be smoked.

### CROSS-REFERENCE TO RELATED APPLICATIONS

This application is a continuation-in-part of patent application Ser. No. 16/794,417 filed on Feb. 19, 2020 that was a continuation-in-part of patent application Ser. No. 16/241,385 filed on Jan. 7, 2019, which was a continuation-in-part of patent application Ser. No. 15/587,340 filed on May 4, 2017 issued as U.S. Pat. No. 10,173, 185, that claimed priority of Provisional Application No. 62/344,202 filed on Jun. 1, 2016.

### BACKGROUND OF THE INVENTION

### 1. Field of the Invention

The invention generally relates to smoking devices and, more specifically, to a vibrating hookah and method of using same.

2. Description of the Prior Art

A hookah is a single- or multi-stemmed instrument for heating or vaporizing tobacco, flavored tobacco or sometimes cannabis, hashish or opium. The smoke is passed through a water-filled basin—often glass-based—before inhalation.

The hookah dates back to the 16^{th} Century and spread from India and Asia to many countries around the world. While the designs of hookahs have adopted regional styles and materials they have continued to share common functional features. Typically, hookahs include a bowl that holds the coal and tobacco. After the bowl is filled with tobacco it is covered by a screen or perforated aluminum foil on which lit coals are placed that heat the tobacco to temperatures up to 450 degrees. The jar below the bowl is filled with water to submerge a lower end of a body tube leading from the bowl. Suction though a mouthpiece draws in air over the coals that is heated and passes through the tobacco producing a vapor or aerosol directed through the water in the jar cooling the vapor before it can be inhaled.

More contemporary hookahs increasingly use stainless steel and aluminum instead of copper and brass. However, while new materials make modern hookahs more durable, eliminate odors while smoking and allow washing without risks of corrosion or bacterial decay hookahs continue to share problems of fluctuating temperatures of briquettes due to uneven burning and cool spots due to the build up of ash on the surfaces of the briquettes. Hookahs continue to rely on ash on the surfaces of coals to drop as a result of excessive buildup or occasional manual shaking to loosen the ash to expose the coals to oxygen in order to maintain desired temperatures of the coals and, therefore, the consistent production of aerosols or vapors. However, because the burning coals change from either being totally coated by ash to having at least portions of the burning coals exposed the surface temperatures of the coals or briquettes can substantially fluctuate. This, in turn, prevents the vapor to be produced with a consistent quality.

A hookah with an ash separator or screen is disclosed in BR102015012777A2. The top of the hookah or the bowl is where charcoal briquettes are placed to heat the air that is drawn in. Once the briquettes are covered with ash they are manually transferred from the top of the hookah and deposited on the screen or ash separator. The reference teaches that when transferred, the burning charcoal cores are separated from the ashes as these are deposited in the compartment formed between the screen and the plate. After this procedure, the coal is again transferred onto the bowl and the session is continued. This reference is typical in that ash on charcoal briquettes is removed manually by moving the briquettes back and forth between the bowl and the ash separator screen.

An ash holder for a hookah is disclosed in DE202020103424U1. Combustion material generates ash and an ash plate is provided that has an ash opening for accommodating an ash collecting container by being placed below the ash plate or placed above the ash plate. However, there is no mechanism for easily, conveniently and effectively removing ash from the burning briquettes.

### SUMMARY OF THE INVENTION

Accordingly, it is an object of the invention to provide a hookah that overcomes the inherent disadvantages in most existing hookahs. It is another object of the invention to provide a hookah that is easy and convenient to use. It is still another object of the invention to provide a hookah that can maintain the temperature of heating briquettes with little or no manual action of the user.

It is yet another object of the invention to provide a hookah that is simple and easy to use. It is a further object of the invention to provide a hookah as in the previous objects that is simple in construction and economical to manufacture. It is still further object of the invention to provide a vibrating device that can be formed as an OEM with a hookah or can be added as an aftermarket attachments for use with existing hookahs.

It is yet a further object of the invention to provide a hookah that can operated using wireless signals such as by a cell phone app. In order to achieve the above objects, as well as others that will become evident hereinafter, a hookah in accordance with the invention comprising, along a generally vertical axis, a column or stem provided with a channel for passage of air, smoke or the like. A container is provided below the column or stem in fluid-flow communication with the channel and for receiving water or liquid and having a base on which the hookah can rest on a surface. A bowl or head is positioned above the column or stem in fluid-flow communication with the channel and includes a perforated member arranged generally transversely to the axis to form a lower region for receiving a substance to be smoked and an upper region for receiving and supporting charcoal or the like in close proximity to the substance to be smoked. A down stem extends the channel into the container to a position in close proximity to the base. A hose port is in fluid-flow communication with the interior of the container. A hose is connected at one end to the hose port and provided with a mouthpiece at another end. A vibrating device selectively vibrates at least the bowl or head whereby a material such as charcoal that forms an outer layer of ash can be selectively vibrated to break up and release the ash to expose burning core of the material, such as charcoal, to oxygen to enhance consistent combustion and the uniform generation of heat that can be applied to the substance to be smoked.

### BRIEF DESCRIPTION OF THE DRAWINGS

The above and other aspects, features and advantages of the present invention will be more apparent from the following description when taken in conjunction with the accompanying drawings, in which:

FIG. 1 is a frontal perspective view of a hookah in accordance with the invention;

FIG. 2 is an enlarged front elevational view, partially in cross-section, of the hookah shown in FIG. 1, showing a vibration device secured just below the bowl or head of the hookah; and

FIG. 3 is an enlarged perspective view of the apertured metal plate shown in FIG. 2.

### DETAILED DESCRIPTION

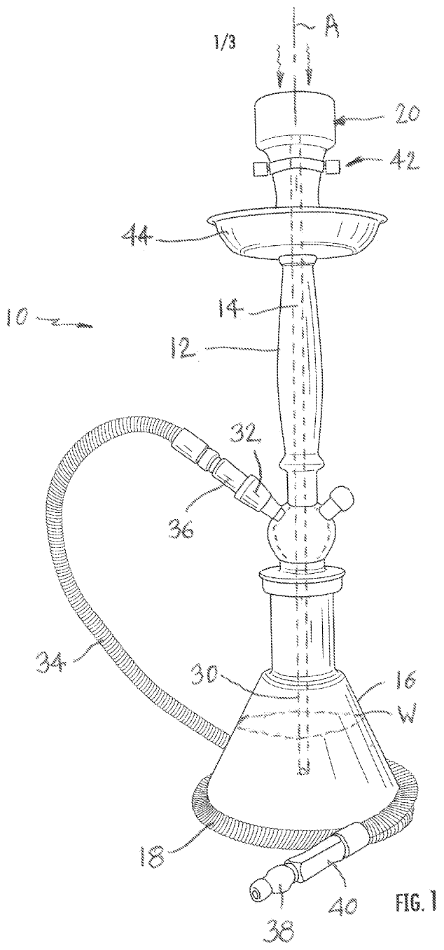

Referring now specifically to the Figures, in which identical or similar parts are designated by the same reference numerals throughout, and first referring to FIG. 1, a hookah, in accordance with the invention, is generally designated by the reference 10.

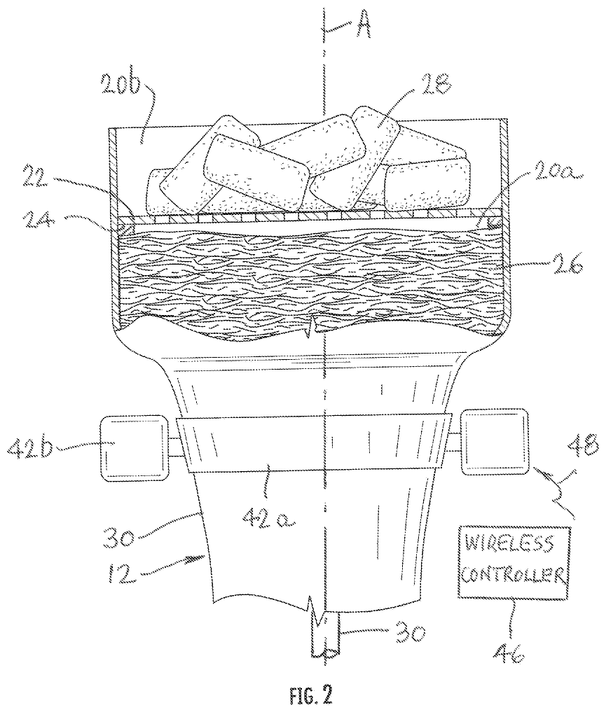

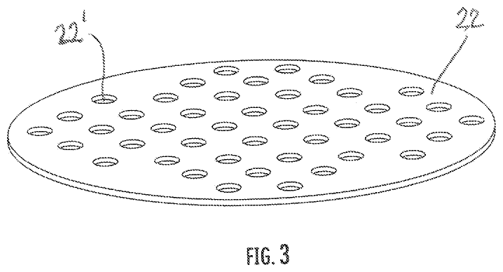

The hookah 10 includes, along a generally vertical axis A, a column or stem 12 provided with a channel 14 for passage of air, smoke and the like. A container 16 below the column or stem is in fluid-flow communication with the channel for receiving water or liquid W and having a base 18 on which the hookah rests on a surface. The bowl or head 20 is located above the column or stem 12 in fluid-flow communication with the channel 14 and includes a perforated member 22, shown in FIGS. 2 and 3, arranged generally transverse to the axis A forming a lower region 20a for receiving a substance 26 to be smoked and an upper region 20b for receiving and supporting charcoal 28 or the like in close proximity to the substance to be smoked. The perforated member or metal plate 22 can be secured to the bowl or head 20 in any suitable or conventional manner, such as a ring 24 that projects inwardly from the wall of the bowl so that the metal plate 22 can be easily removed for cleaning as well as removing smoked or spent tobacco in the lower region 20a.

A down stem 30 is in fluid-flow communication with the channel 14 and extends the channel into the container 16 to a position in close proximity to the base 18. The hookah 10 includes a hose port 32 in fluid-flow communication with the interior of the container 16. A hose 34 is connected at one end 36 to the hose port 32 and provided with a mouthpiece 38 at the other end 40.

An important feature of the invention is the provision of the vibrating device 42 for selectively vibrating at least the bowl or head 20. In the embodiment shown, the vibrating device 42 includes a collar 42a that circumscribes the periphery of the column or stem 12 just below or in close proximity to the bowl or head 20. The collar 42a can be secured to the column or stem in any suitable or conventional manner such as a press fit, fasteners, adhesives or the like. Attached to the collar 42a is a vibrating element 42b so that vibrations generated by the vibrating element 42b is transmitted to the collar 42a and, in turn, to the bowl or head 20. The nature of the vibrating element 42b is not critical and any device that can vibrate and impart vibrations to the collar 42a can be used. Thus, for example, the vibrating element 42b may be a continuous annular ring that surrounds the column or stem. The vibrating element can also comprise one or more discrete vibrating elements secured to the collar. Thus, 1, 2, 3 or more vibrating elements can be spaced from each other about the collar 42a. If more than one vibrating element are utilized they will preferably vibrate in unison or in a synchronized manner so as to reinforce the vibrations on the column or stem and not in opposition to cancel or reduce the strength of the vibrations. Thus, the vibrating elements are controlled to selectively vibrate at least the bowl or head 20 so that the vibrations are transmitted to the burning charcoals or briquettes. The vibrating device may be any known or suitable vibrating element such as a micro-motor or piezoelectric element.

With the use of a vibrating device as described, consumable materials such as charcoals or briquettes 28 placed on top of the metal plate 22 that form an outer layer of ash can be selectively vibrated to break up and release the ash formed thereon to expose the interior burning cores of the briquettes to oxygen to thereby enhance combustion and the generation of heat that can be applied to the substance 26 to be smoked to enhance consistent combustion and the uniform generation of heat that can be applied to the substance to be smoked.

As best shown in FIG. 3 the metal plate includes an array of perforated holes or apertures 22′. While not critical the holes have diameters within the range of 1/32 to 1/16 inch, although the perforated member can also be in the nature of an aluminum foil provided with an array of perforations or holes as has commonly been used heretofore.

An ash plate or tray 44 may be positioned below the bowl or head 24 for receiving consumed charcoal or the like as well as ash accumulated on the perforated member. Such removal or movement of consumed charcoal and ash is performed manually to make room that can be populated with additional fresh charcoal or briquettes.

According to a feature of the invention, the vibrating devices or elements 42b can be controlled by a wireless controller 46 by means of wireless signals 48 such as Wi-Fi or cellular signals as well as Bluetooth signals. As such, the vibrating devices can be programmed to vibrate within desired predetermined intervals to ensure that accumulated ash is automatically removed without human intervention. Also, by effectively retaining the interior burning cores exposed the temperatures remain substantially constant to provide consistent and reliable quality of the resulting vapor.

A method in accordance with the invention includes the steps of providing a channel along a vertical axis for passage of air, smoke and the like. A container is positioned below the column or stem in fluid-flow communication with the channel for receiving water or liquid and having a base in which the hookah can rest on a surface. A bowl or head is positioned above the column or stem in fluid-flow communication with the channel and includes a perforated member in the form of metal plate oriented generally transversely to the axis to form a lower region for receiving a substance to be smoked and an upper region for receiving and supporting charcoal or the like in close proximity to the substance to be smoked. A down stem is provided for extending the channel into the container to position a lowermost free end in close proximity to the base. A hose port is in fluid-flow communication with the interior of the container. A hose is connected at one end to the hose port and provided with a mouthpiece at the other end. A vibrating device is provided for selectively vibrating at least the bowl or head. The method comprises the steps of determining when ash has accumulated on the exteriors of the charcoal or the like; actuating the vibrating device to break up and release the ash to expose the material, such as charcoal, to oxygen thereby enhance combustion and, generation of heat that can be applied to the substance to be smoked.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A hookah comprising, along a generally vertical axis, a column or stem provided with a channel for passage of air, smoke and the like; a container below the column or stem in fluid-flow communication with the channel and for receiving water or liquid and having a base on which the hookah can rest on a surface; a bowl or head above the column or stem in fluid-flow communication with the channel and including a perforated member arranged generally transversely to the axis to form a lower region for receiving a substance to be smoked and an upper region for receiving and supporting charcoal or the like in close proximity to the substance to be smoked; a down stem for extending the channel into the container to a position in close proximity to the base; a hose port in fluid-flow communication with the interior of the container; a hose connectable at one end to the hose port and provided with a mouthpiece at another end; and vibrating means for selectively vibrating at least the bowl or head, whereby a material such as charcoal that forms an outer layer of ash can be selectively vibrated to break up and release the ash to expose the material such as charcoal to oxygen to thereby enhance combustion and the generation of heat that can be applied to the substance to be smoked.

2. A hookah as defined in claim 1, wherein said vibrating means comprises a vibrating collar surrounding said column or stem.

3. A hookah as defined in claim 1, wherein said vibrating means includes a micro-motor.

4. A hookah as defined in claim 1, wherein said vibrating means is positioned in close proximity to said bowl or head.

5. A hookah as defined in claim 1, wherein said perforated member comprises a metal plate.

6. A hookah as defined in claim 5, wherein said metal plate is provided with an array of holes.

7. A hookah as defined in claim 6, wherein said holes have diameters within the range of 1/32 to 1/16 inch.

8. A hookah as defined in claim 1, wherein said perforated member comprises aluminum foil provided with an array of perforations.

9. A hookah as defined in claim 1, wherein said perforated member is removable from said bowl or head.

10. A hookah as defined in claim 9, wherein said bowl or head is provided with support means for supporting said perforated member above said lower region.

11. A hookah as defined in claim 1, further comprising an ash plate or tray below said bowl or head for receiving consumed charcoal or the like and ash.

12. A hookah as defined in claim 11, wherein said vibrating means is axially positioned between said bowl or head and said ash plate or tray.

13. A hookah as defined in claim 1, wherein said vibrating means comprises a piezoelectric element.

14. A hookah as defined in claim 1, wherein said vibrating means is controllable by means of wireless signals.

15. A hookah as defined in claim 14, wherein said wireless signals are wi-fi signals.

16. A hookah as defined in claim 14, wherein said wireless signals are blue-tooth signals.

17. A hookah as defined in claim 14, further comprising an software app for controlling said wireless signals.

18. A method of operating a hookah comprising, along a generally vertical axis, a column or stem provided with a channel for passage of air, smoke and the like; a container below said column or stem in fluid-flow communication with said channel and for receiving water or liquid and having a base on which the hookah can rest on a surface; a bowl or head above said column or stem in fluid-flow communication with said channel and including a perforated member arranged generally transversely to said axis to form a lower region for receiving a substance to be smoked and an upper region for receiving and supporting charcoal or the like in close proximity to the substance to be smoked; a down stem for extending said channel into said container to a position in close proximity to said base; a hose port in fluid-flow communication with the interior of said container; a hose connectable at one end to said hose port and provided with a mouthpiece at another end; and vibrating means for selectively vibrating at least said bowl or head, the method comprising the steps of determining when ash has accumulated on said charcoal or the like; and actuating said vibrating means to break up and release the ash to expose the material such as charcoal to oxygen to thereby enhance combustion and the generation of heat that can be applied to the substance to be smoked.

19. A method of operating a hookah as defined in claim 18, wherein determination of when ash has accumulated is performed by visual inspection.

20. A method of operating a hookah as defined in claim 18, wherein determination of when ash has accumulated is performed automatically in accordance with preset parameters.
